(19) United States
(12) Patent Application Publication
(10) Pub. No.: US 2013/0017940 A1
(43) Pub. Date: Jan. 17, 2013

(54) MACHINES AND METHODS FOR PRODUCING PACKAGING BOXES

(71) Applicant: Lorenzo Bonariva, Castiglione Torinese (Torino) (IT)

(72) Inventor: Lorenzo Bonariva, Castiglione Torinese (Torino) (IT)

(73) Assignee: M.G. AUTOMAZIONI DI LORENZO BONARIVA, Castiglione Torinese (Torino) (IT)

(21) Appl. No.: 13/547,086

(22) Filed: Jul. 12, 2012

(30) Foreign Application Priority Data
Jul. 15, 2011 (IT) TO2011A000626

(51) Int. Cl. B31B 1/25

(52) U.S. Cl. 493/59

(57) ABSTRACT

Machines for manufacturing cardboard packaging boxes including a conveyor system for advancing sheets (F) of cardboard from an inlet station to a output station are provided. Such machines may include a cutting station, for making cuts in the sheets (F) in predetermined positions, and a folding and gluing station, downstream of the cutting station, for folding the sheets along score lines and applying adhesive to the sheets. The cutting station may be provided with one or more laser devices, associated with servomechanisms controlled in synchronization with the conveyor system, for directing laser beams which make cuts and/or score lines in the sheets (F) moved by the conveyor system.

### CROSS REFERENCE TO RELATED APPLICATION

This application claims priority to and benefit of Italian Patent Application No. TO2011A000626 filed Jul. 15, 2011, the contents of which are incorporated by reference in their entirety.

### FIELD OF THE INVENTION

The present invention relates to machines and methods for manufacturing packaging boxes produced from flat sheets of cardboard or similar materials.

### BACKGROUND OF THE INVENTION

Machines for manufacturing packaging boxes from corrugated cardboard, flat card or the like, wherein such boxes are produced from flat sheets which are cut to shape by means of rotating metal punches are known. These cutting tools are constructed in an appropriate way on each occasion according to the shape and dimensions of the packaging to be produced. Downstream of the cutting station, the equipment includes folding and gluing stations, where shaped sheets are folded, glued and stacked in a flattened state. Upstream of the cutting station there is generally provided an ink printing station for applying identifying marks of the product and of the producer to the surfaces of the sheet which face outward after the completion of the packaging.

Machines of the aforesaid type always require:
substantial investment in the construction of the cutting tools, each of which can be used only for cutting boxes of a single type and format;
substantial investment in the construction of printing frames to create the impressions to be printed on the packaging;
long intervals for the adaptation of the machine to different types or formats of packaging to be produced on each occasion;
variable and upredictable waiting times when new production runs are to be started.

### SUMMARY OF THE INVENTION

The invention overcomes the aforesaid drawbacks by providing innovative, flexible machine which reduces the time required for preparation of the machine while considerably simplifying control and programming activities. It is desired, particularly, to manufacture packaging boxes having different formats, including packages made in limited production.

These and other objects are fully achieved according to the present invention by a machine for manufacturing packaging boxes having the features described herein and in the claims.

### BRIEF DESCRIPTION OF THE FIGURES

FIG. 1 is a schematic side view of an embodiment of a machine according to the invention.

FIG. 2 is an enlarged cross-sectional view, taken through line II, of a laser cutting station of the machine of FIG. 1.

FIG. 3 is an enlarged cross-sectional view, taken through line III, of the laser marking station of the machine of FIG. 1.

FIG. 4 is a schematic illustration of the operation of a mirror galvanometer which can be used as a servomechanism for controlling the laser beam generated in the stations of FIGS. 2 and 3.

FIG. 5 is an enlarged plan view, taken in the direction of the arrow V, of the laser cutting station of FIG. 1.

### DETAILED DESCRIPTION

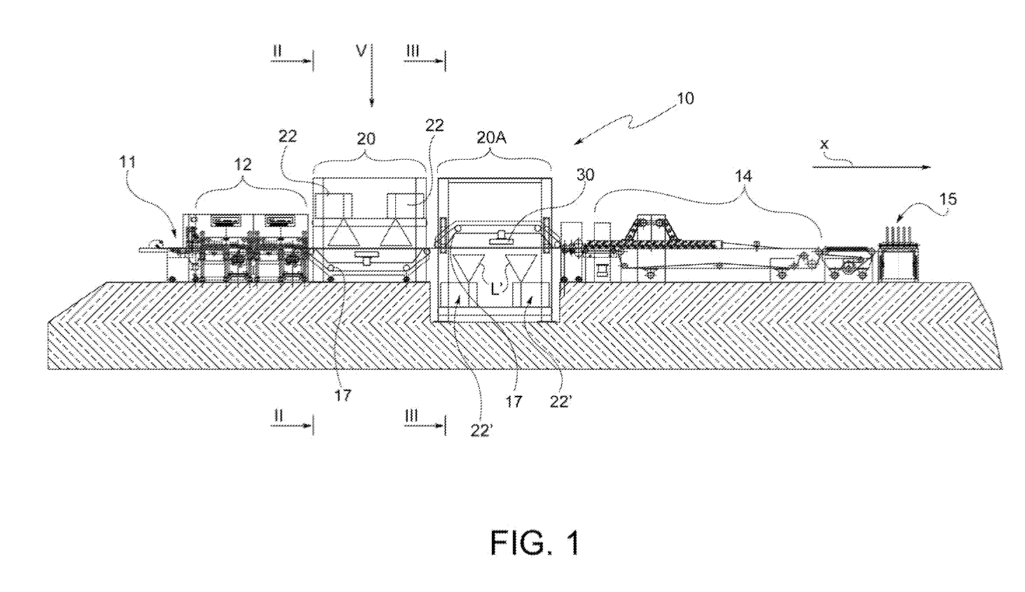

With reference initially to FIG. 1, machines 10 for manufacturing cardboard boxes may include a series of successive processing stations by means of which the cardboard sheet is advanced, cut, folded along score lines, marked, glued along one or more edges, and finally stacked in a flattened state with other boxes having the same format. The stations of the machine 10 in the illustrated example include an initial inlet station 11, a printing station 12, a laser cutting station 20, a laser marking station 20A, a folding and gluing apparatus 14, and a output station 15, including a removal and counting unit which forms stacks or packs of flattened boxes.

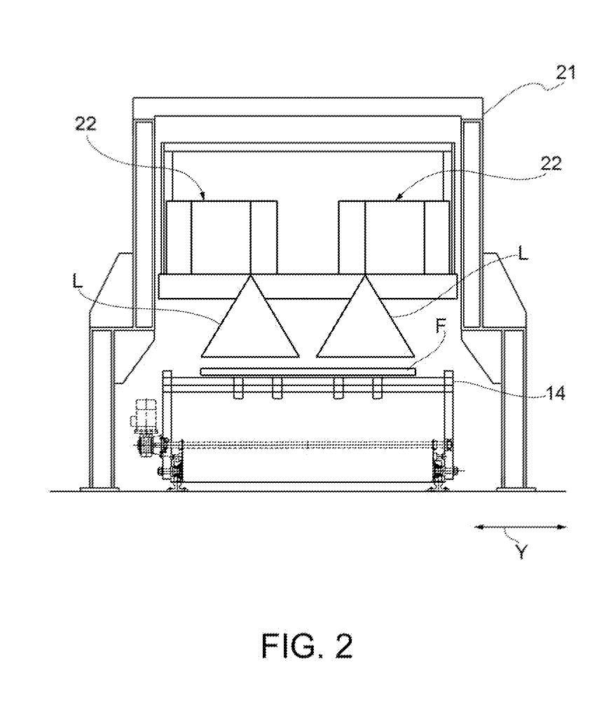

The basic features of the machine shown in FIGS. 1 and 2 is considered to be known overall. In the remainder of the present description, therefore, the only elements described in detail will be those of particular relevance and interest for the purposes of implementing the present invention.

Although the present disclosure refers to sheets of cardboard in general, the invention is applicable to various materials used in the paper and cardboard industry, such as corrugated cardboard, flat card, card of any thickness, extruded and expanded polystyrene with or without added paper or printed plastic films, and the like.

Packs of flat cardboard sheets F may be fed into inlet station 11, these sheets being stacked and optionally pre-cut to the format (generally rectangular) which has the required dimensions for the formation of a box. The sheets F may be picked up one at a time, in succession, from the inlet station 11, through known automated procedures. As explained hereinafter, the machine makes cuts and score lines in the sheets, in order to identify the various faces and peripheral flaps in the sheets according to a precise predetermined profile, as a result of which the box may be constructed subsequently by the appropriate folding of the sheets along the score lines.

Printing station 12 is optional. In the illustrated exemplary embodiment, the printing station comprises two printing units 12a, 12b which are consecutive in the direction x of advance which the machine imparts to the sheets. If provided, the printing units are preferably of the colour printing type.

A conveyor belt and roller advance system 17 may extend from the inlet station 11 to the output removal unit 15, thus passing through the whole machine in a horizontal direction of advancement x which is referred to herein as “longitudinal”. The horizontal direction y is referred to herein as “transverse”. As used herein, terms and expressions such as “downstream” and “upstream” are to be construed with reference to the direction of longitudinal advancement of the intermediate products or blanks (the sheets) through the machine during the production process sequence.

The cutting station 20 may make use of one or more laser beam devices which make the cuts and scores in the moving (or stationary) sheets of cardboard as required for the subsequent folding of the sheets. In certain embodiments stationary laser generators associated with corresponding servomechanisms are used to control the laser beams as explained below.

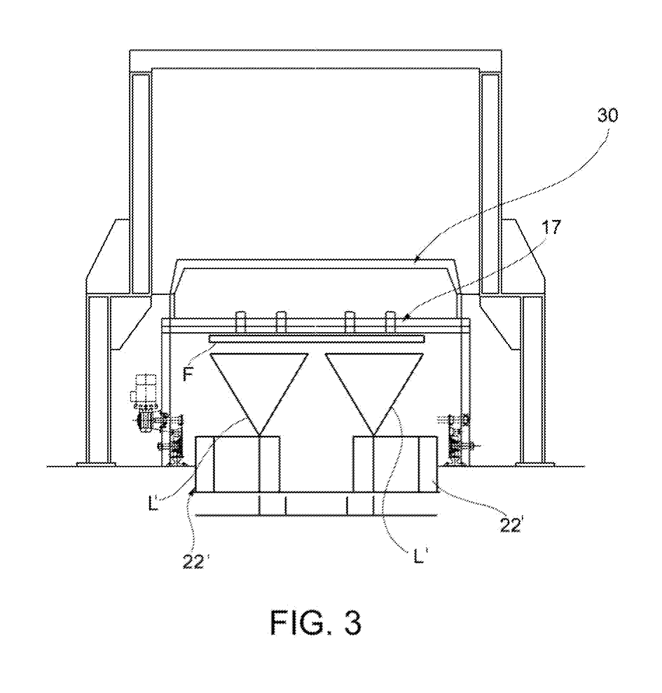

One or more further laser beams may be used for marking the cardboard, in other words for leaving marks or information on or in the surfaces of the cardboard sheets by removing the outermost surface parts of the sheets. In the illustrated example, the laser beams which make the cuts and scores may be generated and controlled by the upper part of the cutting station 20, and act on the upwardly turned faces of the sheets F (FIG. 2). The laser beam or beams which mark the cardboard are generated and controlled by the lower part of the marking station 20A, and strike the downwardly turned faces of the sheets (FIG. 3). In the illustrated embodiment, the upwardly turned faces of the sheets F are intended to form the inner surfaces of the boxes, while the downwardly turned lower faces are intended to form the outer surfaces.

The machine shown in the attached drawings may operate on both the lower and the upper faces of the sheets F, using laser devices arranged on opposite sides of the horizontal operating and transport plane defined by the advance system 17. The following description therefore refers almost exclusively to a single laser device, on the understanding that other laser devices may be used with the present invention.

In order to project each laser beam onto the moving cardboard sheet, the beam may be deflected by mirrors controlled by a corresponding servomechanism controlled so as to deflect the beam both as a function of the shape and position of the cut or score to be made, and as a function of the linear velocity (which may even be zero) of the sheet which is made to advance by the conveyor system. The cutting station may comprise a support structure 21, of the portal or gantry type in this example, which extends above the advance system 17.

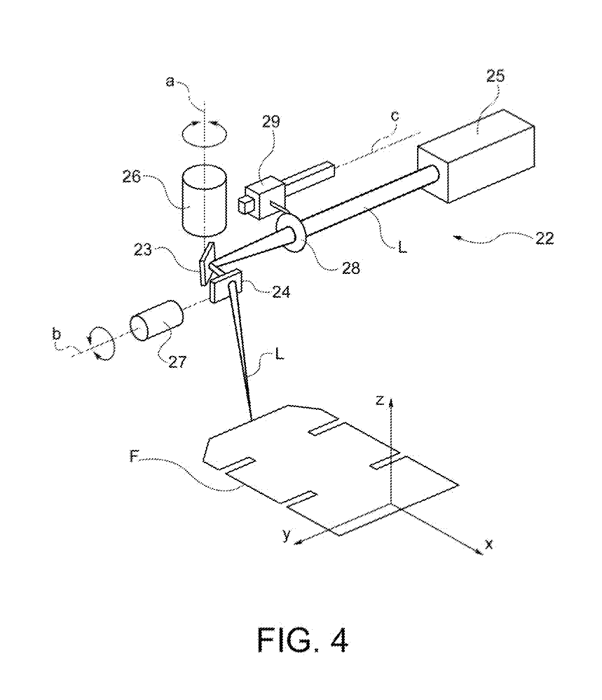

In the particular illustrated embodiment, each laser beam L is generated by a corresponding laser generator 25 which is mounted on the stationary supporting structure 21 and guided by a mirror galvanometer, shown schematically in FIG. 4 and designated overall as 22. This type of servomechanism may comprise a pair of reflecting mirrors 23, 24 whose rotary movements are controlled in a galvanometric manner, and a system of powered lenses indicated schematically as 28. The lenses 28 serve to focus the laser beam, which is concentrated with the maximum specific energy, on any point of the working plane xy. The two mirrors 23, 24 may be mounted rotatably about two respective axes a, b which are perpendicular to each other. The mirrors may be rotated about these axes by respective electrical actuators 26 and 27.

FIG. 4 shows a fixed device, known as a “galvo head”, which may include the mirrors 23, 24 and a powered focusing lens system 28; only one lens is shown in the schematic drawing of FIG. 4. The focusing lens 28, which may be associated with a further lens (not shown), is movable along an axis c parallel to or coincident with the direction in which the laser beam exits the generator 25. The position of the movable focusing lens along the axis may be controlled by a linear electrical actuator 29.

The movements of the mirrors and of the lenses along said axes and about the axes may be controlled numerically by an electronic control and processing unit (not shown). The electronic unit may be provided with application software for controlling the movements of the mirror galvanometer (or other servomechanism), for acquiring the shape data of the profile to be cut, marked or scored, for acquiring the conveyor movement data, and for processing and generating the electrical signals which control the movements of the mirror galvanometer in a coordinated way in synchronization with the advancement of the sheet along the conveyor belt. For this purpose, the electronic unit may be associated with an encoder (not shown) or other instrument capable of providing, in real time, the data on the instantaneous position and velocity of the blanks travelling on the conveyor belt. The position and velocity data received by the electronic unit may be processed and combined with the data on the shape of the cuts, scores or marks to be made, with consequent generation of the commands which control the laser beam on the surface of the sheet so as to describe virtually any desired cutting line, score line, or marking line on the sheet. In other words, the mirrors may be rotated in order to trace the desired line, while the lens is moved to focus the laser beam on any point of the working plane where the beam is required to act. The encoder associated with the conveyor can provide real time information on the position and the speed of the sheet to be processed. Focusing should be controlled as a function of the distance of the point of incidence of the laser beam from the galvo head.

In order to enable the laser beams generated in the lower part of the marking station 20A to reach any part of the lower faces of the sheets F, in one embodiment the advance system may include a pneumatic negative pressure (vacuum) suspension device 30. The device 30 generates suction which acts on the upper faces of the sheets F, transporting them in a raised condition and leaving their lower faces completely free. As a result of the suction, the upper faces of the sheets are kept in contact with the advance/conveyor system 17 which causes them to move toward the next station. The marking station may be equally well-located either downstream or upstream of the cutting station. In certain embodiments, these two stations are immediately adjacent to each other and consecutive in the direction of advance x. In one embodiment, the two stations can be located in coincident positions along the sheet advance path, one station being placed above the sheet path and the other station being placed below it. In this case, the rollers or other movable support means of the advance system should be positioned in such a way that they act on parts of the surfaces of the sheets which are not to be struck by the laser beams.

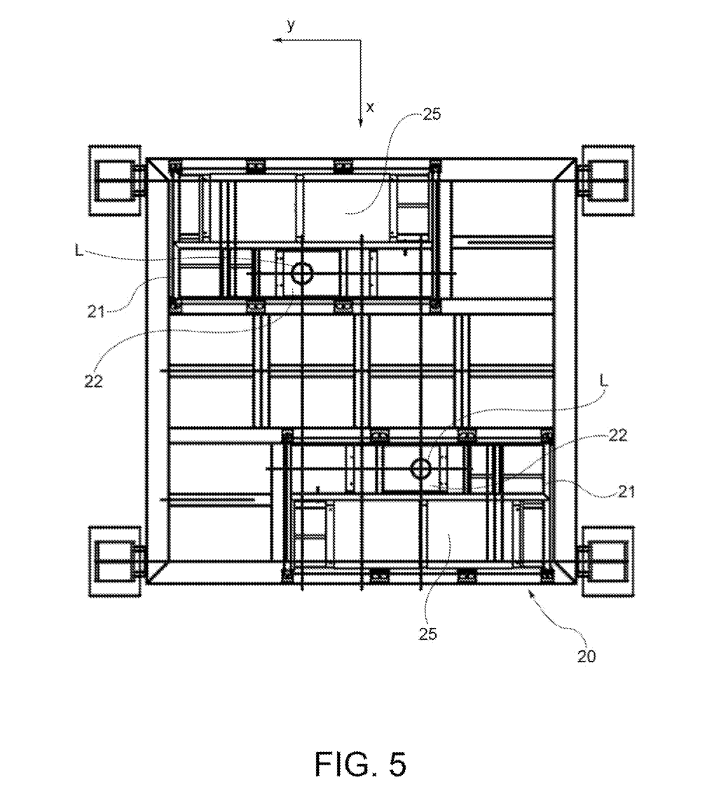

In the illustrated embodiment (see also FIG. 5), two laser devices are provided in each laser station 20, 20A. Both in the cutting station 20 and in the marking station 20A, the control servomechanisms 22, 22′ are offset both in the direction x of advance of the sheets and in the transverse horizontal direction y, thereby causing the laser beams L, L′ to reach in an optimal way all areas of the sheets being processed.

In certain embodiments, the laser devices are associated with a set of means (not shown) used for industrial laser processing, such as a beam expander for increasing the diameter of the laser beam, and two or more mirrors or “beam benders”, used for improving the quality of the laser beam so that it can be manipulated more satisfactorily with the galvanometer.

In certain embodiments, the laser generator may be controllable to modulate the output power of the laser beam as a function of the thickness or consistency of the sheets F to be cut, scored or marked.

In certain embodiments, the laser generator may be power modulated in a selective manner to leave cuts or scores, or to mark the sheets. In the last-mentioned case, the laser beam leaves marks or information (such as bar codes) on or in the surfaces of the cardboard sheets, by ablation of the outermost surface of the sheets.

The power of the laser beam is generally kept constant during the cutting process. However, if it is desired to mark the cardboard on its surface only, it may be preferable to modulate the power of the beam during the processing of a sheet, in accordance with the marks or images, such as black and white images, which are to remain visible on the cardboard. In such applications it may be preferable to modulate the power in a gradual and continuous manner. In other cases, for example, where discrete cuts are to be made, the laser beam must be switched rapidly between the on and off modes. More generally, the power control may be of the analogue or the digital type, according to requirements. In certain embodiments, the electronic unit, suitably programmed with dedicated software,
sends the signals required by the beam guidance system to the servomechanism 22 in order to control the profile to be obtained and/or the position of the marking to be made, and
using the same program, sends the necessary signals to the laser generator 25 for modulating the power of the output beam to create black and white effects of the marking and to set the optimal cutting power as a function of the thickness and/or the consistency of the sheet material.

The possibility of controlling the power of the laser beam advantageously enables the cutting station machine to be used for making score lines (i.e., lines of weakness forming preferential folding lines). Conventionally, scoring is carried out with rollers which, when processing a corrugated cardboard, also deform the intermediate corrugated layer. The scoring carried out by means of a laser enables broken lines of weakness to be created solely in the outer layer of a sheet of corrugated cardboard, without crushing the intermediate corrugated layer. Breaking tests (“crash tests”) conducted on boxes made according to the invention have shown greater strength in the edge areas affected by scoring.

Experimental tests conducted by the applicant have indicated that excellent results may be obtained with a CO₂ laser source, which in the present state of the art can generate a laser beam having a wavelength of about 10 microns (e.g. 10.6 microns) which is ideal for materials such as cardboard and the like. Other types of laser generators, such as optical fibre or disc lasers (including later-developed devices) may be used, provided that they are capable of emitting laser beams having an effective wavelength for the aforesaid purposes.

The flat cardboard sheets leaving the cutting station are already marked and have the appropriate cuts and scores already made when they enter the folding and gluing station 14. The folding and gluing station 14, located downstream of the cutting station 20, is known in the art and does not need to be described in detail herein. It will be sufficient to mention that the folding and gluing station has a series of inclined slides and other fixed stop elements which are impacted by the sheets transported by the conveyor belt, thereby forcing the sheets to fold according to a predetermined geometry. Generally, but not necessarily, adhesive dispensing means are provided to join two or more flaps of the same sheet.

The output and counting unit 15 forms a package of a known type, and is a device which stacks a certain number of folded boxes in a flattened state, thus forming a package (not shown) which is then removed from the machine.

It will be appreciated that the profile of the sheet and any marks to be made thereupon may be produced and modified easily by means of a software program which may be stored in the electronic unit without the need to change any mechanical component, thereby providing evident advantages of flexibility and economy of equipment. It will be appreciated that laser cutting stations make it unnecessary to use conventional cutting stamps or blades which are produced specifically for cutting each format of the cardboard sheets. The precision of cutting which can be achieved with the laser is generally not less than that which can be achieved with a blade. The edges of a sheet of cardboard or the like, when cut by a laser beam, are less sharp than edges cut by conventional cutting tools, thus preventing injuries to the hands of persons handling the boxes. Unless color marks are to be applied to the packaging, the conventional printing station can be dispensed with. The operations performed by the laser devices do not cause any deceleration or stopping of the movement of the sheets, and therefore do not interrupt the production process.

It will be appreciated that the accuracy with which the laser beam can be oriented, as well as the reduced moving mass (basically only two mirrors to be rotated) renders the mirror galvanometer an ideal instrument for controlling the laser beam, both for cutting and scoring purposes.

In an alternative embodiment, the electronic control and processing unit may be programmed differently, according to requirements, in order to have the machine carry out laser operations (cutting, scoring and marking) in the laser stations 20, 20A on the sheets F while these are stationary instead of moving. This will generally require the temporary stopping of the conveyor system 17 in the stations 20, 20A, or the temporary disengagement of sheets F from the conveying system.

In yet another embodiment (not shown), the inlet station 11 may be designed to receive reels (or “rolls”) of card material (not shown) instead of pre-cut sheets. In this variant, the laser cutting station 20 also may be used for cutting portions of the reel which is unwound, thus producing sheets F on which the machine carries out operations like those described above.

Provided that the principle of the invention is retained, constructional details and embodiments can be varied from what has been described and illustrated, without thereby departing from the scope of the invention as defined by the following claims. For example, in an alternative embodiment of the invention, and differently from the machine shown in the drawings, the machine may be provided with at least two laser devices mounted in reversed position with respect to the illustrated embodiment. Particularly, in accordance with that alternative embodiment, at least one of the laser devices, mounted in the cutting station above the horizontal working and transporting plane xy, may be set for sending at least one laser beam which leaves signs or information on the upwardly turned faces of sheet F, whereas a further laser device, mounted in the cutting station 20 underneath the plane xy, may be set for sending at least one laser beam on the downwardly facing sides of the sheets F, so as to leave through-cuts or score lines in sheets F.

1. A machine for manufacturing packaging boxes of cardboard or the like, comprising:
an inlet station for receiving a material in flat sheets (F) or rolls of cardboard or the like;
a conveyor system for advancing sheets (F) of said material from the inlet station to an output station;
at least one cutting station, downstream of the inlet station, for making cuts in said sheets (F) at predetermined positions;
a folding and gluing station, downstream of the cutting station, for folding the sheets along score lines and applying adhesive to the sheets;
wherein the cutting station is provided with at least one laser device, associated with a servomechanism controlled in synchronization with the conveyor system, for directing onto the sheets at least one laser beam which makes cuts and/or score lines in the sheets (F).

2. The machine of claim 1, wherein the conveyor system causes the sheets (F) to pass through the cutting station in a horizontal plane (xy), wherein the cutting station includes at least two laser devices, of which
at least a first laser device, associated with a servomechanism controlled in synchronization with the conveyor system, is mounted in the cutting station on a first side of the horizontal plane (xy) so as to direct at least a first laser beam onto a first face of the sheets (F) facing the first side, to make cuts and/or score lines in the sheets (F), and
at least a second laser device, associated with a servomechanism controlled in synchronization with the conveyor system, is mounted on a second side of horizontal plane (xy), opposite the first side, so as to direct at least a second laser beam to leave marks or information onto a second face of the sheets (F) facing the second side.

3. The machine of claim 1, wherein at least one of said laser devices comprises:
a laser generator mounted in a fixed position on the machine, and
a mirror galvanometer, associated with the generator, and controlled in synchronization with the conveyor system, so as to deflect the laser beam emitted by the generator and focus it on the sheets.

4. The machine of claim 3, wherein the mirror galvanometer comprises:
a pair of reflecting mirrors mounted rotatably about two respective axes (a, b) perpendicular to each other, and rotated about these axes by respective electrical actuators, the rotary movements of which are controlled in a galvanometric manner, and
a power driven lens system comprising at least one lens movable along an axis (c) parallel to or coincident with a direction in which the laser beam exits the generator and associated with a linear actuator for controlling the position of a movable focusing lens along the axis (c) so as to focus the laser beam on any point of the cardboard sheets (F).

5. The machine of claim 2, wherein the conveyor system comprises a suction device acting on upper faces of the sheets (F) for transporting them in a raised position, freeing lower faces of the sheets (F) to enable the second laser device to direct a laser beam on the lower faces.

6. The machine of claim 1, wherein the laser device includes a laser generator capable of generating a laser beam having a wavelength of about 10 microns.

7. The machine of claim 6, wherein the laser generator is a CO₂ laser.

8. The machine of claim 1, wherein said servomechanisms are controlled in synchronization with the conveyor system, so as to direct laser beams onto the sheets (F) as they are moved by the conveyor system.

9. A method for manufacturing packaging boxes of cardboard or the like, comprising the steps of:
providing a machine comprising
an inlet station for receiving a material in flat sheets (F) or rolls of cardboard or the like;
a conveyor system for advancing cardboard sheets (F) from the inlet station to an output station;
at least one cutting station, located downstream of the inlet station, the cutting station being provided with at least one laser generator mounted in a fixed position on the machine, and an associated mirror galvanometer;
a folding and gluing station, located downstream of the cutting station, for folding the sheets along score lines and applying adhesive to the sheets;
advancing continuously the cardboard sheets (F), by means of the conveyor system, from the inlet station to the output station; and
controlling the mirror galvanometer in a synchronized manner with the conveyor system, so as to deflect and focus a laser beam emitted by the laser generator on the cardboard sheets advancing through the cutting station, thereby leaving cuts and/or score lines at predetermined positions in the sheets (F).
